(19) United States
(12) Patent Application Publication
(10) Pub. No.: US 2014/0035714 A1
(43) Pub. Date: Feb. 6, 2014

(54) FERRITE POWDER, METHOD FOR PREPARING THE SAME, AND COMMON MODE NOISE FILTER INCLUDING THE SAME AS MATERIAL FOR MAGNETIC LAYER

(71) Applicants: Sang Moon LEE, Suwon-si (KR); Sung Kwon WI, Suwon-si (KR); Jun Hee BAE, Suwon-si (KR); Young Do KWEON, Suwon-si (KR); Yong Suk KIM, Suwon-si (KR)

(72) Inventors: Sang Moon LEE, Suwon-si (KR); Sung Kwon WI, Suwon-si (KR); Jun Hee BAE, Suwon-si (KR); Young Do KWEON, Suwon-si (KR); Yong Suk KIM, Suwon-si (KR)

(73) Assignee: SAMSUNG ELECTRO-MECHANICS CO., LTD., Suwon-si (KR)

(21) Appl. No.: 13/829,395

(22) Filed: Mar. 14, 2013

(30) Foreign Application Priority Data
Aug. 2, 2012 (KR) 10-2012-0084844

(51) Int. Cl. H01F 3/08; C01G 1/02; C01G 53/04

(52) U.S. Cl. CPC H01F 3/08; C01G 53/04; C01G 1/02
USPC 336/233; 423/594.1; 264/611; 428/402

(57) ABSTRACT

Disclosed herein are a ferrite powder not including pores in a surface thereof, a method for preparing the same, and a common mode noise filter including the same as a material for a magnetic layer. The spherical ferrite powder in which the pores in the surface thereof are removed as a magnetic layer of the common mode noise filter has high density, such that dispersibility is improved, thereby making it possible to improve adhesive strength with a polymer binder to be mixed. In addition, the adhesive strength between the polymer binder and the ferrite powder is improved, such that at the time of manufacturing or mounting of a chip, a defect such as a crack generated by a thermal impact due to a lack of adhesive strength between the ferrite powder and the polymer binder may be suppressed, thereby securing the reliability with respect to the thermal impact.

### CROSS REFERENCE(S) TO RELATED APPLICATIONS

This application claims the benefit under 35 U.S.C. Section 119 of Korean Patent Application Serial No. 10-2012-0084844, entitled “Ferrite Powder, Method for Preparing the Same, and Common Mode Noise Filter Including the Same as Material for Magnetic Layer” filed on Aug. 2, 2012, which is hereby incorporated by reference in its entirety into this application.

### BACKGROUND OF THE INVENTION

1. Technical Field

The present invention relates to a ferrite powder, a method for preparing the same, and a common mode noise filter including the same as a material for a magnetic layer.

2. Description of the Related Art

Electronic devices around us generate more or less radiation noise. Since noise freely and suddenly changes, noise immunity allowing an electronic device itself not to generate noise and preventing an electronic device from malfunctioning caused by external noise has been required. This is the basis of electromagnetic compatibility (EMC).

Generally, conduction noise may be bypassed’ to a ground by a condenser, or ‘be absorbed’ by a resistor and a ferrite core, a chip bead, or the like, to thereby be converted into heat and then removed.

As a measure against the conduction noise, there is another important method. That is a method of “reflecting” noise current using a property of an inductor. The inductor allows a direct current to easily flow, but allows an alternate current not to easily flow due to increased impedance (resistance for the alternate current). However, as a transferring type of conduction noise, there are two types; a differential mode type and a common mode type. Therefore, a measure against noise according to a type of noise is required. If the type of the noise is not confirmed, even though a noise suppression component is added to a circuit, the noise may further increase.

The common mode is a conduction mode in which the noise transfers in the same direction with respect to an outward path and a return path. The common mode noise may be generated by impedance unbalance of a wiring system. In addition, the higher a frequency is, the more significant the common mode noise occurs. In addition, since the common mode noise is also transferred to the ground, or the like, to return while drawing a large loop, various noise disturbances may be generated even in a distant electronic device.

Therefore, in a digital device, a measure against the common mode noise is regarded as important as or more important than a measure against the differential mode noise.

A common mode noise filter 10 has a structure in which a ferrite substrate 11 is installed with an insulation layer 13 having internal coil conductors 12 formed therein, wherein the internal coil conductors 12 are connected to via electrodes (not shown), and then the substrate is connected to external terminal electrodes 14 at an outer peripheral surface thereof, as shown in FIG. 1. In addition, an inner portion of the coil conductor 12 is provided with an opening part 15 penetrating through the insulation layer 13, and the opening part 15 includes a magnetic layer 16 filled with a magnetic material and formed therein.

A structure of FIG. 1 viewed from above is shown in FIG. 2.

The magnetic layer 16 is configured of a ferrite composite formed by mixing a ferrite and a polymer binder with each other, wherein the ferrite uses one kind of powder or two kinds of powder having a different size. However, in the case in which spherical ferrite powder are used in order to increase a filling ratio of the ferrite composite, at the time of manufacturing or mounting of a chip, a defect such as a crack may be generated by thermal impact due to a lack of adhesive strength between the ferrite and the polymer binder.

In addition, in order to improve a permeability value, a method of increasing a particle size of the ferrite, a method of decreasing an amount of polymer binder, or a method of raising a temperature at the time of molding, or the like, is used. However, when the particle size is increased, high frequency characteristics are deteriorated, and when the amount of polymer binder is decreased, insulation and withstanding voltage characteristics of a green compact may be deteriorated. Further, the method of raising a temperature may cause deterioration of workability, a high cost of the equipment, and a problem in reliability of a filter.

### RELATED ART DOCUMENT

### Patent Document

(Patent Document 1) Japanese Patent Laid-Open Publication No. 2005-306696

### SUMMARY OF THE INVENTION

An object of the present invention is to solve a problem of a winding-type or multi-layer type common mode noise filter according to the related art. According to the present invention, a ferrite powder capable of being used to manufacture a thin-film type common mode noise filter having a precisely fine line-width, excellent connectivity between upper and lower patterns to easily form an internal circuit pattern, and excellent connectivity with an external electrode, as a material for a magnetic layer of the common mode noise filter, and a method for preparing the same may be provided.

Further, another object of the present invention is to provide a thin-film type common mode noise filter having excellent electrical characteristics and reliability using the ferrite powders as a magnetic layer.

According to an exemplary embodiment of the present invention, there is provided a ferrite powder not including pores in a surface thereof.

The ferrite powder may be a Fe—Ni—Zn—Cu based ferrite powder.

The ferrite powder may have an average particle size of 10 to 50 μm.

The ferrite powder may have a spherical shape.

The ferrite powder may further include at least one kind selected from a group consisting of Co, Bi, and Ti.

According to another exemplary embodiment of the present invention, there is provided a method for preparing a ferrite powder not including pores in a surfaces thereof, the method including: mixing a raw material powder of the ferrite powder to spray-dry the mixture; calcining the spray-dried mixture for 30 to 90 minutes at 800 to 900° C.; and reacting the calcined mixture for 100 to 150 minutes at 1000 to 1200° C.

The ferrite powder may be a Fe—Ni—Zn—Cu based ferrite powder and does not include the pores in the surface thereof.

According to another exemplary embodiment of the present invention, there is provided a common mode noise filter including a Fe—Ni—Zn—Cu based ferrite powder not including pores in surfaces thereof as a magnet layer.

The magnetic layer may be configured of a composite of the ferrite powder and a polymer binder.

The polymer binder may be at least one kind selected from a group consisting of an epoxy resin, a polyimide resin, a polyamide resin, and a polyaniline resin.

In the magnetic layer, the ferrite powder and the polymer binder may be mixed at a weight ratio of 7:1 to 10:1.

The ferrite powder may have an average particle size of 10 to 50 μm.

The ferrite powder may have a spherical shape.

The ferrite powder may further include at least one kind selected from a group consisting of Co, Bi, and Ti.

### BRIEF DESCRIPTION OF THE DRAWINGS

FIGS. 1 to 2 are views showing a structure of a common mode noise filter according to the related art.

FIG. 3 is a view showing a structure of a ferrite powder according to an exemplary embodiment of the present invention.

FIG. 4 is a view showing a structure of a ferrite powder according to the related art after calcinations.

FIG. 5 is a view showing a change in a surface structure in each operation of preparing a ferrite powder according to the exemplary embodiment of the present invention.

FIGS. 6 to 7 are views showing a structure of a common mode noise filter according to an exemplary embodiment of the present invention.

FIG. 8 is a view showing a process of manufacturing the common mode noise filter according to the exemplary embodiment of the present invention.

FIG. 9 is a view showing a structure of ferrite powders according to Comparative Example 1.

FIGS. 10 to 15 are graphs measuring a coefficient of thermal expansion (CTE) according to Example 2 according to the present invention and Comparative Example 1.

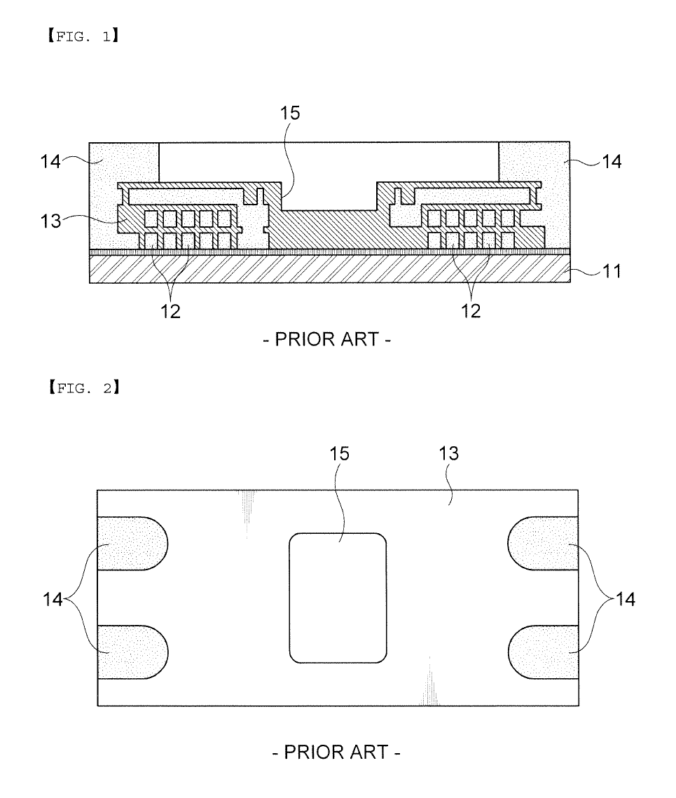

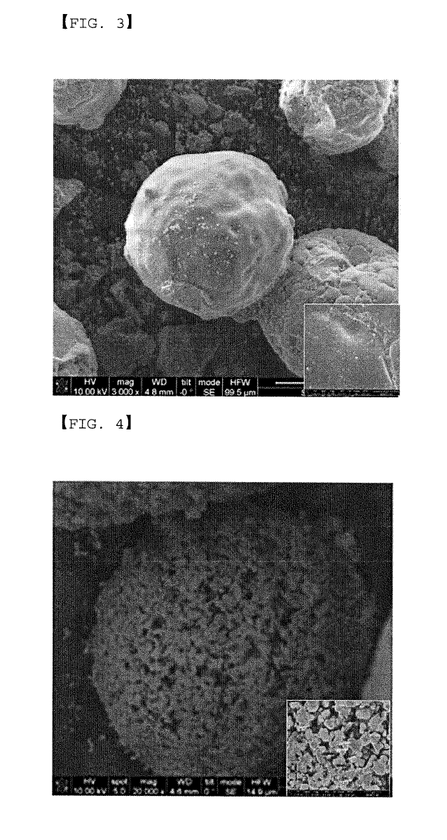

### DESCRIPTION OF THE PREFERRED EMBODIMENTS

Hereinafter, the present invention will be described in more detail with respect to the accompanying drawings.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

The present invention relates to a ferrite powder included as a material for a magnetic layer of a common mode noise filter according to the present invention, a method for preparing the same, and a common mode noise filter including the same as a material for a magnetic layer.

1. Ferrite Powder

The ferrite powder included as the material for the magnetic layer of the common mode noise filter according to the present invention does not include pores in a surface thereof, and this structure is shown in FIG. 3.

As shown in FIG. 3, the ferrite powder according to the present invention has a dense structure in which the ferrite powder does not include the pore in the surface thereof. In the present invention, the meaning of “having a dense structure in which the ferrite powder does not include the pore in the surface thereof” is that the ferrite powder does not substantially include pores, for example, pores having a size of 10 to 1000 nm, or includes pores within about 1 to 5%.

The pore formed in the surface of the ferrite powder was closed by a reaction, such that the ferrite powder according to the present invention not including the pore formed in the surface thereof may be obtained.

As the ferrite powder according to the exemplary embodiment of the present invention, a Fe—Ni—Zn—Cu based ferrite powder may be used, and selectively, at least one kind selected from a group consisting of Co, Bi, and Ti may be further included.

In addition, the ferrite powder according to the present invention may have a spherical shape in order to be uniformly dispersed.

It is preferable in view of improvement of permeability that the ferrite powder according to the present invention has an average particle size of 10-50 μm.

2. Method for Preparing the Ferrite Powder

Hereinafter, a method for preparing the ferrite powder not including the pores in the surface thereof will be described.

The ferrite powder according to the exemplary embodiment of the present invention may be prepared through a process of mixing raw materials for the ferrite powder to spray-dry the mixture, a process of calcining the spray-dried mixture for 30 to 90 minutes at 800 to 900° C., and a process of reacting the calcined mixture for 100 to 150 minutes at 1000 to 1200° C.

In the first step, each of the raw material powders configuring the ferrite powder are mixed with each other using an attrition mill for about 7 to 10 hours, and then the mixture is spray-dried at 200 to 400° C.

Each of the raw materials configuring the ferrite powder may be a Fe—Ni—Zn—Cu based material, and selectively, include at least one kind selected from a group consisting of Co, Bi, and Ti.

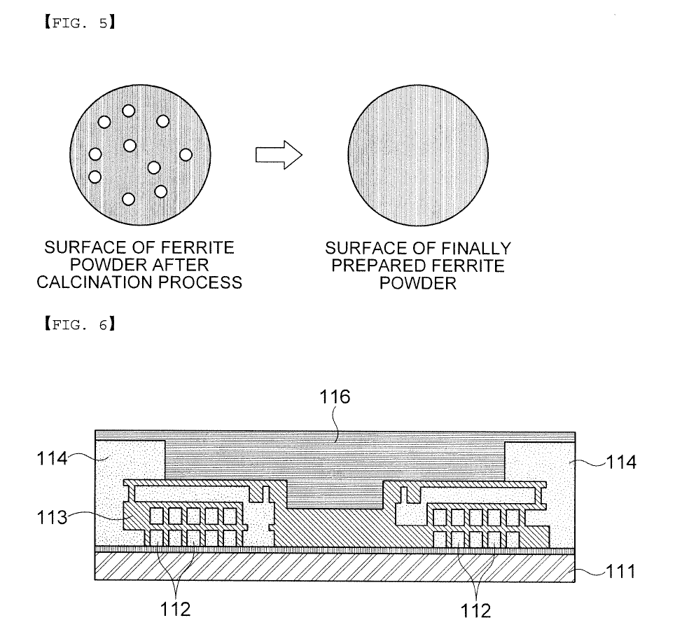

In the second step, the spray-dried mixture is calcined for 30 to 90 minutes at 800 to 900° C. The ferrite powder subjected to the second calcinations step has a structure in which pores having a size of 100 to 700 nm are formed in the surface thereof as shown in FIG. 4. In addition, the ferrite powder has a structure in which fine particles are lumped with each other.

In the third step, the calcined mixtures are reacted with each other for 100 to 150 minutes at 1000 to 1200° C., such that the pores of the surface of the ferrite powder are attached to each other, thereby changing the structure of the ferrite powder into a structure in which the ferrite powder does not include pores in the surface thereof. In FIG. 5, the surface of the ferrite powder after the calcination step and the surface of the finally prepared ferrite powder are compared, wherein the finally prepared ferrite powder has a structure in which the pores of the surface are melted with and attached to each other through a particle-growth reaction to thereby be removed.

In addition, the particles lumped in a large lump state are separated into each of the particles through the above-mentioned reaction. Therefore, in the case in which the lumped particles are individually separated and then used as the material for the magnetic layer, dispersibility with a polymer binder may be improved.

Further, the ferrite powder subjected to the third step has density higher than that of the ferrite powder in the second calcinations process, such that thermal expansion characteristics may be improved. The ferrite powder having an average particle size of about 10 to 50 μm may be obtained through the above-mentioned process.

3. Common Mode Noise Filter

The present invention relates to the common mode noise filter including the ferrite powder described above as the material for the magnetic layer.

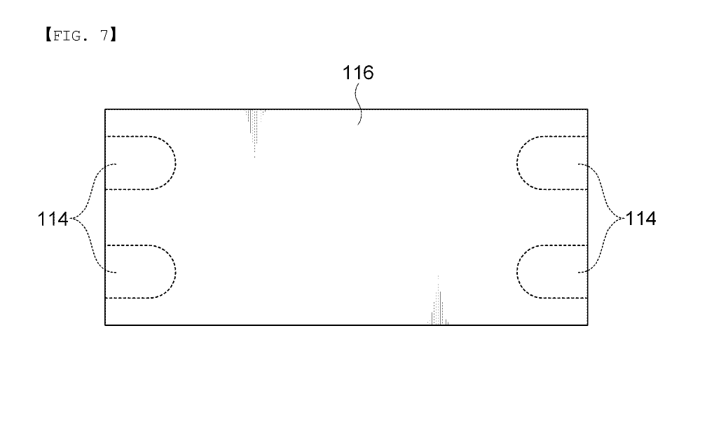

FIG. 6 is a view showing a structure of the common mode noise filter 100 according to the exemplary embodiment of the present invention. Referring to FIG. 3, the common mode noise filter 100 is configured to include a plurality of insulation layers 113 configuring of a laminated body formed on a substrate 111, internal electrode coils 112 included in the plurality of insulation layers 113, external electrode terminals 114 connected to end portions of the internal electrode coil 112, and a magnetic layer 116 formed on a surface of the laminated body.

According to the present invention, the magnetic layer 116 includes a Fe—Ni—Zn—Cu based ferrite powder in which pores are not formed in a surface thereof. Since an average particle size of the ferrite powder is about 10 to 50 μm and the pores are not present in the surface thereof, the ferrite powder has high density and excellent dispersibility.

In addition, the ferrite powder according to the present invention has a spherical shape to effectively reduce the thermal expansion characteristics as compared to a flake shaped powder according to the related art, such that when the ferrite powder is included as the material for the magnetic layer, reliability of the noise filter for thermal impact may be secured.

The magnetic layer 116 according to the exemplary embodiment of the present invention may be configured of a composite of the ferrite powder and the polymer binder.

The polymer binder may be at least one kind selected from a group consisting of an epoxy resin, a polyimide resin, a polyamide resin, and polyaniline resin.

Further, in the magnetic layer 116 including the ferrite powder and the polymer binder in a mixture form according to the embodiment of the present invention, it is preferable in view of the dispersibility and process capability that the ferrite power and the polymer binder are mixed at a weight ratio of 7:1 to 10:1.

In addition, the magnetic layer according to the present invention may include a general additive, such as a dispersant.

It is preferable in view of a wetting property and a defoaming property that the magnetic layer according to the exemplary embodiment of the present invention has a thickness of 50 to 100 μm.

As the substrate 111 used in the common mode noise filter according to the exemplary embodiment of the present invention, a general ferrite substrate may be used, and a material for the ferrite is not particularly limited.

The plurality of insulation layers 113 are laminated on the ferrite substrate 111 to form the laminated body, and each of the insulation layers 113 include the internal electrode coils 112 formed therein. The internal electrode coils 112 of each of the insulation layers 113 are connected to each other by via electrodes adjacent thereto (not shown).

The insulation layer 113 serves to insulate the internal electrode coils 112 from each other and to planarize a surface in which the internal electrode coils 112 are formed. As a material for the insulation layer 113, a polymer resin having excellent electrical or magnetic insulation characteristics and excellent formability, for example, an epoxy resin, a polyimide resin, or the like, may be used, but is not particularly limited thereto.

Further, the internal electrode coil 112 formed in each of the insulation layer 113 may be made of copper (Cu), aluminum (Al), or the like, having excellent conductivity and formability and be formed using an etching method using photolithography, an additive method (a plating method), or the like. However, the method of forming the internal electrode coil is not particularly limited thereto.

The opening part penetrating through each of the insulation layers 113 is formed at a central portion of the insulation layer 113, that is, inner portions of each of the internal electrode coils 112, and the internal electrode coils 112 formed in each of the insulation layers 113 are electrically connected to each other by the via electrodes of each of the insulation layers.

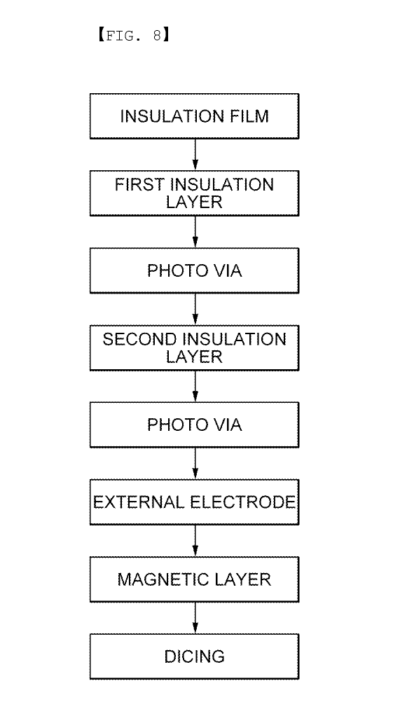

In addition, each end portion of the internal electrode coils 112 is connected to the external electrode terminals 114, and four external electrode terminals 114 are formed at both sides of an outer peripheral surface of the laminated body. FIG. 6 viewed from above is shown in FIG. 7.

FIG. 8 shows a process of manufacturing the common mode noise filter according to the exemplary embodiment of the present invention. Referring to FIG. 8, a first insulation layer is formed on an insulation film that are made of ferrite substrate, and internal electrode coils are formed in the first insulation layer and a second insulation layer and are electrically connected to each other through via electrodes. An outer peripheral end of the internal electrode coil is connected to an external electrode terminal through an outlet terminal.

Next, internal electrode coils of the second insulation layer and a third insulation layer are electrically connected to each other through via electrodes, and the internal electrode coils formed in each of the insulation layers are connected to the external electrode terminal. In addition, a magnetic layer is formed on the outermost insulation layer, and a final common mode noise filter may be manufactured by a dicing process.

The magnetic layer according to the present invention uses the ferrite powder in which the pores are not present in the surface thereof and may be configured to include the polymer binder and an additive. Each of the ferrite powder is mixed under a predetermined condition and then subjected to the spray-drying process, the calcination process, and the reaction process, thereby having the structure in which the pore is not present in the surface thereof. It is preferable in view of a wetting property and a defoaming property that the magnetic layer according to the exemplary embodiment of the present invention has a thickness of 50 to 100 μm.

Hereinafter, Examples of the present invention will be described. The following Examples are only to exemplify the present invention, and the scope of the present invention should not be interpreted to being limited to these Examples. Further, although the following Examples exemplify the present invention using specific compounds, it is obvious to those skilled in the art that the same or similar effect may also be generated in the case of using equivalents to the specific compounds.

### Example 1

### Preparation of Ferrite Powders

Each raw material powders configuring Fe—Ni—Zn—Cu based ferrite powders were mixed in an oxide form using an attrition mill for 9 hours and then spray-dried at 300° C. Small amounts of Co oxide and Bi oxide were included in the ferrite powders. Next, the ferrite powders were calcined for 50 minutes at about 900° C. Finally, the calcined ferrite powders were reacted with each other (were particle-grown) for 120 minutes at 1100° C. to remove the pores in the surface of the ferrite powders, thereby preparing the Fe—Ni—Zn—Cu based ferrite powders having an average particle size of 100 to 6000 nm.

### Example 2

### Manufacturing of a Common Mode Noise Filter

The common mode noise filter was manufactured through the following process shown in FIG. 8. A first insulation layer made of an epoxy resin was formed on an insulation film made of a ferrite substrate, and internal electrode coils were formed on the first insulation layer using a copper (Cu) metal. In addition, internal electrode coils were formed on a second insulation layer made of an epoxy resin using the copper (Cu) metal. An additional insulation layer may be formed by repeating a process of forming the internal electrode coils on each of the insulation layers. Further, the internal electrode coils formed on each of the first and second insulation layers were electrically connected to each other through via electrodes. Outer peripheral ends of the internal electrode coils were connected to external electrode terminals through outlet terminals, and internal electrode coils of the second insulation layer and a third insulation layer were electrically connected to each other through via electrodes, and the internal electrode coils formed in each of the insulation layer were connected to the external electrode terminals.

In addition, a magnetic layer was formed on the outermost insulation layer at a thickness of 100 μm. The ferrite powder prepared in Example 1 and polyimide polymer binder were mixed with each other at a ratio of 9:1 and applied, such that the magnetic layer was formed. Next, a final common mode noise filter was manufactured through a dicing process.

### Comparative Example 1

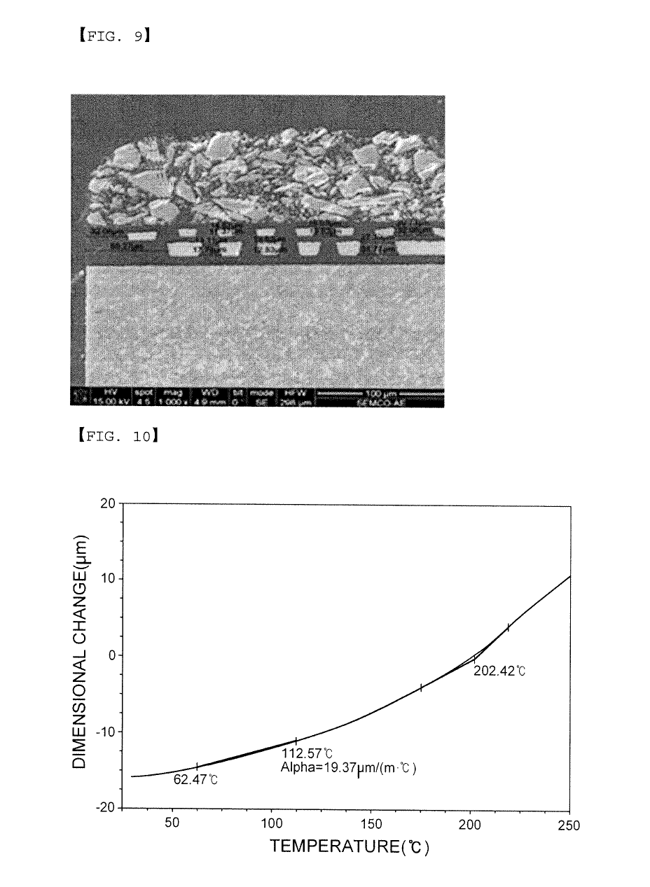

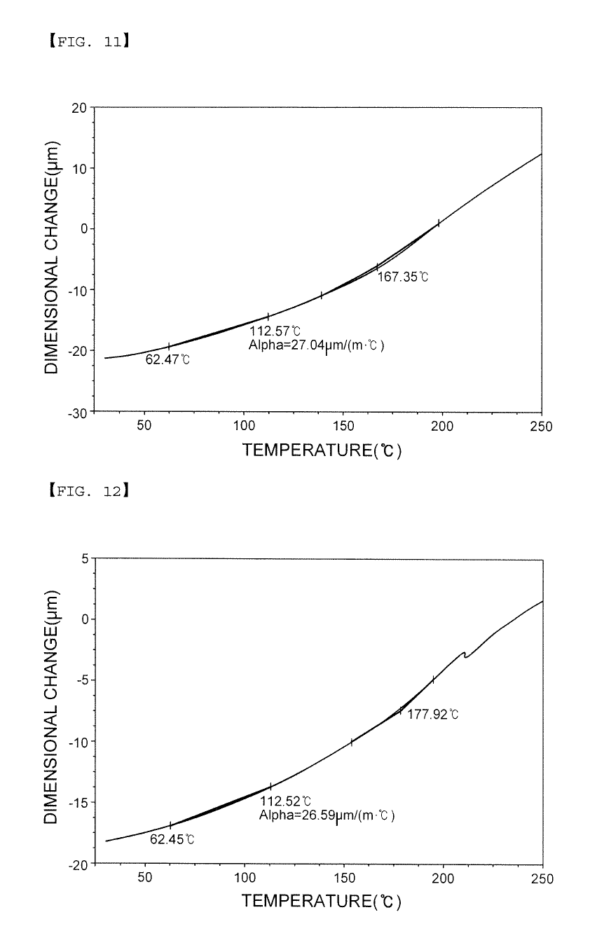

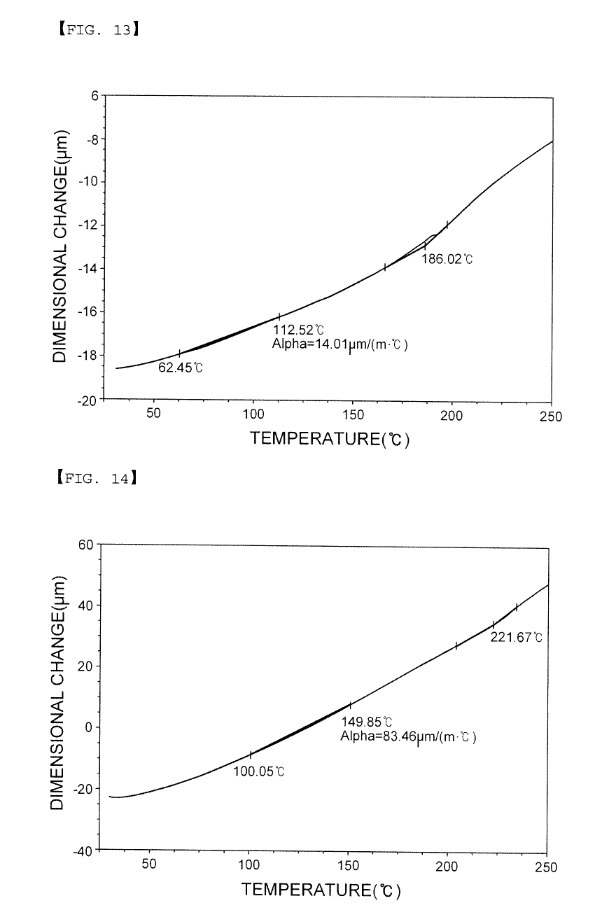

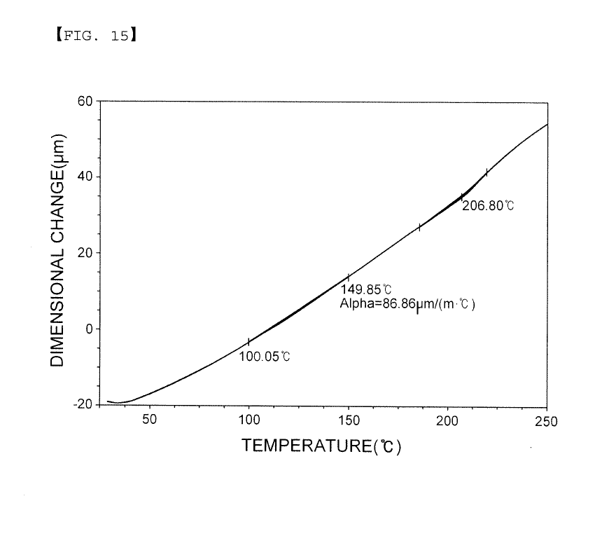

A common mode noise filter was manufactured by the same processes as those in Example 2 except that ferrite powders configured of Fe—Ni—Zn—Cu based material having a plate shape as shown in FIG. 9 and having pores in surfaces of the powders as a material for a magnetic layer was used.

### Experimental Example 1

### Measurement of Density in Each Process

A change in density of the ferrite powder between the calcinations step and the reaction step according to Example 1 of the present invention was measured, and the results were shown in the following Table 1.

TABLE 1

Density (g/cm³)

| | After calcination | After reaction |
|---|---|---|
| Sample | step | step |
| Example 1 | 4.752 | 5.453 |

As the results shown in Table 1, it may be appreciated that the ferrite powder according to the present invention has density significantly increased after the final reaction step as compared to the density after the calcinations step. It may be inferred that this change in the density is made by effectively closing the pores formed in the surface of the ferrite powder after the calcination step in the final reaction step. As described in the present invention, the pores of the surface of the ferrite powder are removed, such that a loss of the polymer binder due to a capillary phenomenon in the pores of the surface of the ferrite powder is reduced, thereby improving dispersibility. In addition, permittivity may be increased due to the increase in density through the particle growth.

### Experimental Example 2

### Measurement of a Coefficient of Thermal Expansion

The coefficient of thermal expansion of the noise filters manufactured from the ferrite particles of Example 2 and Comparative Example 1 were measured, and the results were shown in the following Table 2. In the case of samples of Example 2, the experiment was performed two times using two samples, and in the case of a sample of Comparative Example 1, the experiment was performed two times, respectively, and then the average values were obtained.

TABLE 2

CTE(m.° C.)

| Sample | Before Tg | Average | Tg(° C.) |
|---|---|---|---|
| Example 2-1(primary) | 19.37 | 23.21 | 202.42 |
| Example 2-2(secondary) | 27.04 | | 167.35 |
| Example 2-3(primary) | 26.59 | 20.30 | 177.92 |
| Example 2-4(secondary) | 14.01 | | 186.02 |
| Comparative Example | 83.46 | 85.16 | 211.67 |
| 1-1(primary) | | | |
| Comparative Example | 86.86 | | 206.80 |
| 1-2(secondary) | | | |

As the results shown in Table 2, it was confirmed that the noise filter of Example 2 using the spherical ferrite powder in which the pores are not present in the surface thereof to prepare a composite has a coefficient of thermal expansion (CTE) decreased to ¼ as compared to the Comparative Example 1 using the powder having the pores in the surface thereof and a plate shape, thereby reliability for thermal impact may be secured.

It was shown that the dispersibility of the spherical ferrite powder according to the present invention is increased to increase a contact area with the polymer binder, such that the coefficient of thermal expansion may be decreased.

Further, it was shown that the ferrite powder according to the Examples of the present invention has the same dispersibility as that in the case in which the powders having a size of 100 to 1000 nm are each separately present as compared to the case of the ferrite powder having the pores in the surface thereof (Comparative Examples 1-1, 1-2), and the particle-grown powder has excellent characteristics in view of the coefficient of thermal expansion.

According to the exemplary embodiment of the present invention, a spherical ferrite powder in which the pores in the surface thereof are removed as a magnetic layer of the common mode noise filter has high density, such that dispersibility is improved, thereby making it possible to improve adhesive strength with a polymer binder to be mixed.

In addition, according to the present invention, the adhesive strength between the polymer binder and the ferrite powder is improved, such that at the time of manufacturing or mounting of a chip, a defect such as a crack generated by thermal impact due to a lack of adhesive strength between the ferrite powder and the polymer binder may be suppressed, thereby securing reliability with respect to thermal impact.

Further, the spherical ferrite powder included in the magnetic layer according to the present invention may be easily dispersed, such that the permeability of the common mode noise filter may be improved, thereby making it possible to manufacture the thin-film type common mode noise filter having a fine line-width and a relatively thick thickness.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A ferrite powder not including pores in a surface thereof.

2. The ferrite powder according to claim 1, wherein it is a Fe—Ni—Zn—Cu based ferrite powder.

3. The ferrite powder according to claim 1, wherein it has an average particle size of 10 to 50 μm.

4. The ferrite powder according to claim 1, wherein it has a spherical shape.

5. The ferrite powder according to claim 1, wherein it further includes at least one kind selected from a group consisting of Co, Bi, and Ti.

6. A method for preparing a ferrite powder not including pores in a surface thereof, the method comprising:
mixing raw materials for the ferrite powder to spray-dry the mixture;
calcining the spray-dried mixture for 30 to 90 minutes at 800 to 900° C.; and
reacting the calcined mixture for 100 to 150 minutes at 1000 to 1200° C.

7. The method according to claim 6, wherein the ferrite powder is a Fe—Ni—Zn—Cu based ferrite powder and does not include the pores in the surface thereof.

8. A common mode noise filter including a Fe—Ni—Zn—Cu based ferrite powder not including pores in a surface thereof as a magnet layer.

9. The common mode noise filter according to claim 8, wherein the magnetic layer is configured of a composite of the ferrite powder and a polymer binder.

10. The common mode noise filter according to claim 9, wherein the polymer binder is at least one kind selected from a group consisting of an epoxy resin, a polyimide resin, a polyamide resin, and a polyaniline resin.

11. The common mode noise filter according to claim 9, wherein in the magnetic layer, the ferrite powder and the polymer binder are mixed at a weight ratio of 7:1 to 10:1.

12. The common mode noise filter according to claim 8, wherein the ferrite powder has an average particle size of 10 to 50 μm.

13. The common mode noise filter according to claim 8, wherein the ferrite powder has a spherical shape.

14. The common mode noise filter according to claim 8, wherein the ferrite powder further includes at least one kind selected from a group consisting of Co, Bi, and Ti.
